(19) United States
(12) Patent Application Publication
(10) Pub. No.: US 2014/0268737 A1
(43) Pub. Date: Sep. 18, 2014

(54) DIRECT VIEW OPTICAL ARRANGEMENT

(71) Applicant: CREE, INC., Durham, NC (US)

(72) Inventors: Praneet Athalye, Morrisville, NC (US); Paul Pickard, Morrisville, NC (US)

(73) Assignee: CREE, INC., Durham, NC (US)

(21) Appl. No.: 13/800,517

(22) Filed: Mar. 13, 2013

(51) Int. Cl. F21V 13/04

(52) U.S. Cl. CPC F21V 13/04
USPC 362/235

(57) ABSTRACT

The present disclosure relates to a lighting fixture that has a light source housing that forms a mixing chamber with an opening for a lens assembly having a central area that is bound by a perimeter line. The lens assembly is mounted over the opening. The central area and the perimeter line need not be visible and are simply used to define how one or more LED arrays are mounted within the mixing chamber. The one or more LED arrays are mounted within the mixing chamber and adapted to emit light having a central axis, wherein the central axis passes through and along a portion of the perimeter.

### FIELD OF THE DISCLOSURE

The present disclosure relates to lighting fixtures, and in particular to lighting fixtures that employ a direct view optical arrangement.

### BACKGROUND

In recent years, a movement has gained traction to replace incandescent light bulbs with lighting fixtures that employ more efficient lighting technologies as well as to replace relatively efficient fluorescent lighting fixtures with lighting technologies that produce a more pleasing, natural light. One such technology that shows tremendous promise employs light emitting diodes (LEDs). Compared with incandescent bulbs, LED-based light fixtures are much more efficient at converting electrical energy into light, are longer lasting, and are also capable of producing light that is very natural. Compared with fluorescent lighting, LED-based fixtures are also very efficient, but are capable of producing light that is much more natural and more capable of accurately rendering colors. As a result, lighting fixtures that employ LED technologies are expected to replace incandescent and fluorescent bulbs in residential, commercial, and industrial applications. As such, there is a continuing need for LED-based fixtures that can replace and at least match, and preferably exceed, the optical performance of incandescent and fluorescent bulbs.

### SUMMARY

The present disclosure relates to a lighting fixture that has a light source housing, which forms a mixing chamber. An opening is provided in the light source housing for a lens assembly that has a central area, which is bounded by a perimeter line. The lens assembly is mounted over the opening. The central area and the perimeter line need not be visible and are simply used to define how one or more LED arrays are mounted within the mixing chamber. The one or more LED arrays are mounted within the mixing chamber and adapted to emit light having a central axis wherein the central axis passes through and along a portion of the perimeter line. In one embodiment, the LED arrays are mounted outside of the central area, and thus are angled inward so the central axis will pass through the perimeter line and form an acute angle with a plane in which the LED arrays are located. The one or more LED arrays may be mounted within the mixing chamber and further adapted to emit light having a central axis, wherein the central axis passes through and along about at least one half or more of the perimeter line. In other embodiments, the central axis passes through and along a majority, if not substantially all, of the perimeter line.

In one embodiment, the light source housing has at least one side wall, a back wall opposite the opening, and at least one angled wall that extends between the at least one side wall and the at least one back wall. The lighting source housing may be round, oval, elliptical or the like, wherein there is only one of each wall and each wall curves around to itself. The source housing may also be relatively square, rectangular, or other polygonal-like shape. As such, multiple side and angled walls may be required to form the desired shape. LED arrays may be mounted and/or distributed along an interior surface of each of the angled walls, such that the LED arrays substantially continuously surround the central area. In many instances, at least two of the LED arrays will be mounted on opposing sides of the central area. When the LED arrays are mounted in thermal contact with the interior surface of the light source housing's wall, the light source housing itself may act as a heatsink for dissipating heat generated by the LED arrays during operation. Notably, de-centralizing the LED arrays effectively provides distributed thermal management, and thus further reduces the need for, or at least the size or mass of, any heatsink.

In another embodiment, the average light intensity along the perimeter line is less than or equal to 3, 2.5, or 2 times an average light intensity in the central area to reduce the perception of hotspotting at or along the perimeter line of the lens assembly. By placing the LED arrays outside of the central area and angling them inward towards the perimeter line that defines the central area, the perception of hotspotting within the central area is also reduced.

In other embodiments, a first set of LED arrays may be provided along a first plane that is parallel to the opening, and a second set of LED arrays may be provided along a second plane that is also parallel to the opening. The LED arrays for both sets are angled inward toward inner and outer perimeter lines, respectively. The area between the perimeter lines is a boundary area, wherein the average light intensity along the inner perimeter line, outer perimeter line, and/or the boundary area is less than or equal to 3, 2.5, or 2 times an average light intensity in the central area.

Those skilled in the art will appreciate the scope of the disclosure and realize additional aspects thereof after reading the following detailed description in association with the accompanying drawings.

### BRIEF DESCRIPTION OF THE DRAWINGS

The accompanying drawings incorporated in and forming a part of this specification illustrate several aspects of the disclosure, and together with the description serve to explain the principles of the disclosure.

FIG. 1 is a perspective view of a troffer-based lighting fixture according to a first embodiment of the disclosure.

FIG. 2 is a cross-section of the lighting fixture of FIG. 1.

FIG. 3 is bottom view of the lighting fixture of FIG. 1 wherein the lens assembly is removed to reveal the LED arrays that are mounted within the mixing chamber.

FIG. 4 is bottom view of the lighting fixture of FIG. 1 wherein the lens assembly is in place over the opening into the light source housing.

FIG. 5 is a cross-section of a troffer-based lighting fixture according to a second embodiment of the disclosure

FIG. 6 is bottom view of the lighting fixture of FIG. 5 wherein the lens assembly is in place over the opening into the light source housing.

FIG. 7 is a perspective view of a lighting fixture according to a third embodiment of the disclosure.

FIG. 8 is a bottom view of the lighting fixture of FIGS. 7 and 9.

FIG. 9 is a perspective view of a lighting fixture according to a fourth embodiment of the disclosure.

FIG. 10 is a block diagram of a lighting system according to one embodiment of the disclosure.

FIG. 11 is a cross-section of an exemplary LED according to a first embodiment of the disclosure.

FIG. 12 is a cross-section of an exemplary LED according to a second embodiment of the disclosure.

FIG. 13 is a schematic of a driver module and an LED array according to one embodiment of the disclosure.

FIG. 14 is a block diagram of a communications module according to one embodiment of the disclosure.

### DETAILED DESCRIPTION

The embodiments set forth below represent the necessary information to enable those skilled in the art to practice the disclosure and illustrate the best mode of practicing the disclosure. Upon reading the following description in light of the accompanying drawings, those skilled in the art will understand the concepts of the disclosure and will recognize applications of these concepts not particularly addressed herein. It should be understood that these concepts and applications fall within the scope of the disclosure and the accompanying claims.

It will be understood that relative terms such as “front,” “forward,” “rear,” “below,” “above,” “upper,” “lower,” “horizontal,” or “vertical” may be used herein to describe a relationship of one element, layer or region to another element, layer or region as illustrated in the figures. It will be understood that these terms are intended to encompass different orientations of the device in addition to the orientation depicted in the figures.

The present disclosure relates to a lighting fixture that has a direct view optical arrangement, which can be implemented in various lighting fixture configurations, such as a troffer-type lighting fixture, recessed lighting fixture, can lights (or downlights), surface mount lighting fixtures, suspended lighting fixtures, and the like. For purposes of illustration only, the concepts of this disclosure will be primarily described in the context of a troffer-type lighting fixture. In general, troffer-type lighting fixtures are designed to mount in a ceiling, such as a drop ceiling of a commercial, educational, or governmental facility.

In FIGS. 1-4, an exemplary lighting fixture 10 is shown in isometric, cross-section, and two bottom views, respectively. The primary structure of the lighting fixture 10 includes an outer frame 12, a light source housing 14, and reflectors 16 that extend between the outer frame 12 and a bottom opening in the light source housing 14. A lens assembly 18 is provided over the opening of the light source housing 14. FIGS. 3 and 4 depict the lighting fixture 10 without and with the lens assembly 18, respectively.

With particular reference to FIG. 2, the light source housing 14 is formed from side walls 20, angled walls 22, and a back wall 24. At least the interior surface of the side walls 20, the angled walls 22, and the back wall 24 have reflective surfaces. The side walls 20 extend rearward from the inside of the reflectors 16, and the angled walls 22 extend between the sides walls 20 and the outer periphery of the back wall 24. While it is not necessary to practice the concepts disclosed herein, the back wall 24 is illustrated as being substantially perpendicular to the side walls 20, and the angled walls 22 form an acute angle α that is less than 90° relative to the plane in which the opening in the light source housing lies. In select embodiments, the angle α is between about 10° and 80°, between about 20° and 70°, between about 30° and 60°, about 30°, about 45°, and about 60°. In this embodiment, the lens assembly 18 is planar and substantially parallel with the back wall 24.

For a rectangular light source housing, four angled walls 22 provide a mounting structure for four elongated LED arrays 26, each of which includes a mounting substrate, such as a printed circuit board (PCB) and a number of LEDs. The LEDs of the LED arrays 26 are oriented to generally emit light inward and downward toward the lens assembly 18. The cavity bounded by the lens assembly 18 and the interior of the light source housing 14 provides a mixing chamber 30.

The lens assembly 18 may include a relatively clear lens 32 and a diffuser 34. The degree and type of diffusion provided by the diffuser 34 may vary from one embodiment to another. Further, color, translucency, or opaqueness of the diffuser 34 may vary from one embodiment to another. Diffusers 34, such as that illustrated in FIG. 2, are typically formed from a polymer or glass, but other materials are viable and will be appreciated by those skilled in the art. Similarly, the lens 32 generally corresponds to the shape and size of the diffuser 34 as well as the front opening of the light source housing 14. As with the diffuser 34, the material, color, translucency, or opaqueness of the lens 32 may vary from one embodiment to another. Further, both the diffuser 34 and the lens 32 may be formed from one or more materials or one or more layers of the same or different materials. While only one diffuser 34 and one lens 32 are depicted, the lighting fixture 10 may have multiple diffusers 34 or lenses 32.

Light emitted from the LED arrays 26 is mixed inside the mixing chamber 30 and directed out through the lens assembly 18. The LED arrays 26 may include LEDs that emit different colors of light, as described further below. For example, the LED arrays 26 may each include both red LEDs that emit red light and blue-shifted yellow (BSY) LEDs that emit bluish-yellow light, wherein the red and bluish-yellow light is mixed to form “white” light at a desired color temperature. For a uniformly colored light output, relatively thorough mixing of the light emitted from the LED arrays 26 is desired. Both the reflective interior surfaces of the light source housing 14 and the diffusion provided by the diffuser 34 play a significant role in mixing the light emanated from the LED arrays 26.

In particular, certain light rays, which are referred to as non-reflected light rays, emanate from the LED arrays 26 and exit the mixing chamber 30 through the diffuser 34 and lens 32 without being reflected off of the interior surfaces of the light source housing 14. Other light rays, which are referred to as reflected light rays, emanate from the LED arrays 26 and are reflected off of the reflective interior surfaces of the light source housing 14 one or more times before exiting the mixing chamber 30 through the diffuser 34 and lens 32. With these reflections, the reflected light rays are effectively mixed with each other and at least some of the non-reflected light rays within the mixing chamber 30 before exiting the mixing chamber 30 through the diffuser 34 and the lens 32.

As noted above, the diffuser 34 functions to diffuse, and as a result mix, the non-reflected and reflected light rays as they exit the mixing chamber 30, wherein the mixing chamber and the diffuser 34 provide the desired mixing of the light emanated from the LED arrays 26 to provide a light output of a consistent color, color temperature, or the like. In addition to mixing light rays, the lens 32 and diffuser 34 may be configured and the interior of the light source housing 14 and reflectors 16 shaped in a manner to control the relative distribution and shape of the resulting light beam that is projected from the lighting fixture 10. For example, a first lighting fixture 10 may be designed to provide a concentrated light output for a spotlight, wherein another may be designed to provide a widely dispersed light output. From an aesthetics perspective, the diffusion provided by the diffuser 34 also prevents the emitted light from looking pixelated, and obstructs the ability for a user to see the individual LEDs of the LED arrays 26. As described further below, the orientation of the LED arrays 26 plays a role in controlling light output as well as apparent, or at least perceived, distribution of light along the surface of the lens assembly 18.

As provided in the above embodiment, the more traditional approach to diffusion is to provide a diffuser 34 that is separate from the lens 32. As such, the lens 32 is effectively transparent and does not add any intentional diffusion. The diffuser 34 provides the intentional diffusion. As a first alternative, the diffuser 34 may take the form of a film that is directly applied to one or both surfaces of the lens 32. Such film is considered a “volumetric” film, wherein light diffusion occurs within the body of the diffusion film. One exemplary diffusion film is the ADF 3030 film provided by Fusion Optix, Inc. of 19 Wheeling Avenue, Woburn Mass. 01801, USA. As a second alternative, the lens assembly 18 may be configured as a composite lens, which provides the functionality of both the lens 32 and the diffuser 34. Such a composite lens may be a volumetric lens, which means the light passing through the composite lens is diffused in the body of the composite lens. The composite lens referenced above could be made of a diffusion grade acrylic or a polycarbonate material such as Bayer Makrolon® FR7087, Makrolon® FR7067, with 0.5% to 2% diffusion doping or Sabic EXRL0747-WH8F013X, EXRL0706-WHTE317X, LUX9612-WH8E490X and LUX9612-WH8E508X. The WHxxxxxx defines the degree of diffusion.

The electronics used to drive the LED arrays 26 are shown provided in a single driver module 36; however, the electronics may be provided in different modules. Further, these electronics may be provided with wired or wireless communications ability, as represented by the illustrated communications module 38. At a high level, the driver module 36 is coupled to the LED arrays 26 through cabling and directly drives the LEDs of the LED arrays 26 based on one or a combination of internal logic; inputs received from another device, such as a switch or sensor; or control information provided by the communications module 38. In the illustrated embodiment, the driver module 36 provides the primary intelligence for the lighting fixture 10 and is capable of driving the LEDs of the LED arrays 26 in a desired fashion. Notably, primary intelligence of the lighting fixture may reside in the communications module 38 in select embodiments.

The communications module 38 may act as a communication interface that facilitates communications between the driver module 36 and other lighting fixtures 10, sensors (not shown), switches (not shown), a remote control system (not shown), or a portable handheld commissioning tool 40, which may also be configured to communicate with a remote control system in a wired or wireless fashion. The commissioning tool 40 may be used for a variety of functions, including the commissioning of a lighting network or modifying the operation, configurations, settings, firmware, or software of the driver module 36 and the communications module 38. Details of an exemplary configuration that employs a driver module 36 and a communications module 38 are provided further below.

With particular reference to FIGS. 2 and 4, an exemplary optical arrangement is illustrated. The LED arrays 26 are effectively line arrays that predominantly emit light from a line source. The line source, while illustrated as being a straight line with the straight LED arrays 26 of FIGS. 2 and 4, may be a curvilinear line. The light emitted from the LED arrays 26 has a central axis A_{C}, which is perpendicular to and extends from the face of the LED arrays 26 and effectively corresponds to the center of the beam of light emitted from each of the line arrays provided by the LED arrays 26. The central axis A_{C} extends from the face of the LED arrays 26 through a line, which is referred to as a perimeter line PL, on the lens assembly 18. The perimeter line PL forms a boundary of a central area CA of the lens assembly 18. While the LED arrays 26 may, but need not, completely encircle the central area CA, the essential shape of the imaginary perimeter line PL is defined to substantially coincide with the layout of the LED arrays 26. As such, the central axis A_{C} that is associated with the light generated by the LED arrays 26 will generally pass through and along a portion of the perimeter line PL. The central axis A_{C} may pass through and along about at least one half or more of the perimeter line PL, and in other embodiments, the central axis A_{C} passes through and substantially completely along the entirety of the perimeter line PL.

In the illustrated embodiment, the layout of the LED arrays 26 is effectively a rectangle (or square), and as such, the shape of the perimeter line PL is rectangular (or square), wherein the line arrays of the LED arrays 26 correspond to a substantial portion of the linear sides of the rectangle formed by the perimeter line PL. The LED arrays 26 need not run completely along or extend to the corners of the rectangular-shaped perimeter line PL. Other shapes for the layout of the LED arrays 26, and thus the corresponding perimeter line PL, may include polygons, circles, ovals, and the like.

With continued reference to FIGS. 2 and 4, the LED arrays 26 are mounted outside of the central area CA and emit light that has a central axis A_{C} that is angled inward toward the central area CA. In particular, the central axis A_{C} forms an acute, central axis angle β relative to a plane in which the perimeter line PL resides. In the case of a planar lens assembly 18, as illustrated in FIGS. 1-4, the plane in which the perimeter line PL resides coincides with the plane of the lens assembly 18. The central axis angle β is generally between about 10° and 80°, between about 20° and 70°, between about 30° and 60°, about 30°, about 45°, or about 60°.

Ideally, the light emitted from the LED arrays 26 will mix in the mixing chamber 30, pass through the lens assembly 18, and reflect as desired off of the reflectors 16 in such a manner to emit light in a desired distribution pattern. A further desire is to have the lens assembly to appear relatively uniformly lit when the light is being emitted from the lighting fixture 10. In other words, there is a desire to relatively evenly distribute the light exiting the mixing chamber 30 across the entirety of the lens assembly 18. A relatively even distribution of light across the lens assembly 18 prevents, if not greatly reduces, the appearance of optical “hot” spots on the outside face of the lens assembly 18.

Hot spots are a result of a portion of the lens assembly 18 appearing to an observer to be significantly brighter than other portions of the lens assembly 18. Hotspotting would occur in the illustrated lighting fixture 10 if LEDs were clustered tightly together and placed on the back wall 24, such that a significant portion of the light emitted from the LEDs would pass light through the lens assembly 18 at a right angle in the central area CA. In this configuration, hotspotting would occur with the central area CA, while the areas outside of the central area CA would be much less bright from an observer's perspective. Most traditional lighting fixtures are configured in this manner. The concepts disclosed herein represent a significant technological advance in reducing hotspotting on the outside face of the lens assembly 18.

Two key parameters that dictate how light is distributed across the lens assembly 18 are the central axis angle β and the relative distance d between the LED arrays 26 and lens assembly 18. Since the lens assembly 18 need not be planar, the average distance d between the plane in which the LED arrays 26 reside and the plane in which the perimeter line PL for the central area CA resides is used for purposes of discussion. While there is not a particular central axis angle β or distance d that ensures proper light distribution across the lens assembly 18 in multiple embodiments, the interplay of these metrics along with the configuration of the LED arrays 26 and the lens assembly 18 as well as the shape and reflectivity of the interior of the mixing chamber 30 will primarily dictate how light is distributed across the lens assembly 18.

The light striking any point on the lens assembly 18 is a combination of direct and reflected light from each of the different LED arrays 26. For certain embodiments, the above noted metrics of the lighting fixture 10 are configured to ensure a light distribution as defined below. The resulting light distribution significantly reduces or eliminates hotspotting anywhere on the lens assembly 18, and in particular, below the locations of the LED arrays 26.

In one embodiment, the lighting fixture 10 is configured such that an average light intensity along the perimeter line PL is less than or equal to three times the average light intensity of central area. To even further reduce hotspotting, the lighting fixture 10 is configured such that the average light intensity along the perimeter line PL is less than or equal to 2.5 or 2 times the average light intensity of the central area. The average intensity metric is measured on the outside surface of the lens assembly.

With reference to FIGS. 5 and 6, the lighting fixture 10 may be equipped with multiple sets of LED arrays 26. In the illustrated embodiment, a first set of LED arrays 26A are mounted on the angled wall 22 in a first plane, and the second set of LED arrays 26B are mounted on the angled wall 22 in a second plane. As such, a corresponding perimeter line PL for the first set of LED arrays 26A is referred to as the inside perimeter line IPL and is provided on the lens assembly 18. The corresponding perimeter line PL for the second set of LED arrays 26B is referred to as the outside perimeter line OPL and is also provided on the lens assembly 18 outside of the inside perimeter line IPL. The central axis A_{C1} for the first set of LED arrays 26A effectively dictates the inside perimeter line IPL, and the central axis A_{C2} for the second set of LED arrays 26B effectively dictates the outside perimeter line OPL. The inside perimeter line IPL defines the central area CA, and the area between and including the inside perimeter line IPL and the outside perimeter line OPL defines a border area BA. Both the first and second set of LED arrays 26A and 26B are outside of the outer perimeter line OPL.

In one embodiment, the lighting fixture 10 shown in FIGS. 5 and 6 is configured such that an average light intensity along the inside and outside perimeter lines IPL, OPL, or in certain embodiments, the entire border area BA is less than or equal to three times the average light intensity of central area CA. To even further reduce hotspotting, the lighting fixture 10 is configured such that the average light intensity along the inside and outside perimeter lines IPL, OPL, and in certain embodiments, the entire border area BA is less than or equal to 2.5 or 2 times the average light intensity of central area CA. Again, the central axis angle β and the distance d for each of the LED arrays 26A and 26B will play a significant role. Those skilled in the art will recognize that innumerable configurations, shapes, sizes, and the like, are available that fall within the concepts provided herein.

With reference to FIGS. 7, 8, and 9 a lighting fixture 10 is provided with a substantially circular shape to illustrate just one of many possible configurations. As shown in FIGS. 7 and 9, the side wall 20, angled wall 22, and back wall 24 form a circular light source housing 14, which may provide a circular mixing chamber 30 (not shown) therein. The lens assembly 18 shown in FIG. 7 is circular and is substantially planar. The lens assembly 18 shown in FIG. 9 is hemispherical (or globular), and thus, not planar. FIG. 8 is a bottom view of the lighting fixture and illustrates an exemplary perimeter line PL that defines a central area CA for either of the embodiments of FIGS. 7 and 9. The LED array 26 is shown mounted along the interior of the angled wall 22 and resides in a plane that is substantially parallel with the back wall 24, opening from the mixing chamber 30, or the planar lens assembly of FIG. 7. As with any of the embodiments, the LED arrays 26 need not be mounted directly to the angled wall 22, but can be mounted to any type of interior mounting structure that resides within the light source housing 14. As such, the exterior or interior shape of the light source housing 14 need not dictate the shape or size of the mixing chamber 30 or how the LED array or arrays 26 are mounted.

In one embodiment, the light source housing 14 is made of a material that has a high coefficient of thermal conductivity, such as aluminum, and the LEDs of the LED arrays 26 are thermally coupled to the light source housing 14. In this configuration, a light source housing 14 may act as a heat sink, thereby avoiding the need for an additional heat sink to be attached to the light source housing or the LED arrays 26. In particular, If the LEDs of the LED array 26 are thermally coupled with the interior surface of the angled walls 22 through thermally conductive elements in the PCB, heat generated by the LEDs will flow through the thermally conductive elements to the angled walls 22. From the angled walls 22, the heat may spread over the angled walls 22 and further to the side walls 20, the back wall 24, reflectors 16, outer frame 12, or other parts of the light source housing 14 and dissipate in a safe and effective manner. By using the light source housing 14, and perhaps the reflectors 16, as a heat sink, a separate, specially configured heat sink may not be needed. In other embodiments, a separate heat sink may be employed and mounted to the side or rear portion of the light source housing 14.

Turning now to FIG. 10, a block diagram of a lighting fixture 10 is provided according to one embodiment. Assume for purposes of discussion that the driver module 36, communications module 38, and LED arrays 26 are ultimately connected to form the core electronics of the lighting fixture 10, and that the communications module 38 is configured to bidirectionally communicate with other lighting fixtures 10, the commissioning tool 40, or any other entity through wired or wireless techniques. In this embodiment, a defined communication interface and protocol are used to facilitate communications between the driver module 36 and the communications module 38.

In the illustrated embodiment, the driver module 36 and the communications module 38 are coupled via a communication bus (COMM BUS) and a power bus (PWR BUS). The communication bus allows the driver module 36 to exchange data or commands with the communications module 38. An exemplary communication bus is the well-known inter-integrated circuitry (I²C) bus, which is a serial bus and is typically implemented with a two-wire interface employing data and clock lines. Other available buses include: serial peripheral interface (SPI) bus, Dallas Semiconductor Corporation's 1-Wire serial bus, universal serial bus (USB), RS-232, Microchip Technology Incorporated's UNI/O®, and the like.

The driver module 36 may be coupled to an AC (alternating current) power source via the AC IN port. The AC power may be controlled via a remote switch, wherein when an AC signal is applied, the driver module 36 will power on and provide appropriate drive currents to the LEDs of the LED arrays 26. The AC power signal may be provided to include a desired dimming level, which is monitored by the driver module 36 and used to control the drive currents to provide a light output intensity corresponding to the dimming level. Alternatively, a separate dimming signal (not shown) from the AC power signal may be provided to the driver module 36, wherein the driver module 36 will control the drive currents based on the dimming signal.

In this embodiment, the driver module 36 is optionally configured to collect data from an integrated, or at least associated, ambient light sensor S_{A}, an occupancy sensor S_{O}, or other sensor. The driver module 36 may use the data collected from the ambient light sensor S_{A} and the occupancy sensor S_{O} to control how the LEDs of the LED arrays 26 are driven. The data collected from the ambient light sensor S_{A} and the occupancy sensor S_{O} as well as any other operational parameters of the driver module 36 may also be shared with the communications module 38 or other remote entities via the communications module 38.

A description of an exemplary embodiment of the LED arrays 26, driver module 36, and the communications module 38 follows. As noted, the LED arrays 26 include a plurality of LEDs, such as the LEDs 42 illustrated in FIGS. 11 and 12. With reference to FIG. 11, a single LED chip 44 is mounted on a reflective cup 46 using solder or a conductive epoxy, such that ohmic contacts for the cathode (or anode) of the LED chip 44 are electrically coupled to the bottom of the reflective cup 46. The reflective cup 46 is either coupled to or integrally formed with a first lead 48 of the LED 42. One or more bond wires 50 connect ohmic contacts for the anode (or cathode) of the LED chip 44 to a second lead 52.

The reflective cup 46 may be filled with an encapsulant material 54 that encapsulates the LED chip 44. The encapsulant material 54 may be clear or may contain a wavelength conversion material, such as a phosphor, which is described in greater detail below. The entire assembly is encapsulated in a clear protective resin 56, which may be molded in the shape of a lens to control the light emitted from the LED chip 44.

An alternative package for an LED 42 is illustrated in FIG. 12 wherein the LED chip 44 is mounted on a substrate 58. In particular, the ohmic contacts for the anode (or cathode) of the LED chip 44 are directly mounted to first contact pads 60 on the surface of the substrate 58. The ohmic contacts for the cathode (or anode) of the LED chip 44 are connected to second contact pads 62, which are also on the surface of the substrate 58, using bond wires 64. The LED chip 44 resides in a cavity of a reflector structure 66, which is formed from a reflective material and functions to reflect light emitted from the LED chip 44 through the opening formed by the reflector structure 66. The cavity formed by the reflector structure 66 may be filled with an encapsulant material 54 that encapsulates the LED chip 44. The encapsulant material 54 may be clear or may contain a wavelength conversion material, such as a phosphor.

In either of the embodiments of FIGS. 11 and 12, if the encapsulant material 54 is clear, the light emitted by the LED chip 44 passes through the encapsulant material 54 and the protective resin 56 without any substantial shift in color. As such, the light emitted from the LED chip 44 is effectively the light emitted from the LED 42. If the encapsulant material 54 contains a wavelength conversion material, substantially all or a portion of the light emitted by the LED chip 44 in a first wavelength range may be absorbed by the wavelength conversion material, which will responsively emit light in a second wavelength range. The concentration and type of wavelength conversion material will dictate how much of the light emitted by the LED chip 44 is absorbed by the wavelength conversion material as well as the extent of the wavelength conversion. In embodiments where some of the light emitted by the LED chip 44 passes through the wavelength conversion material without being absorbed, the light passing through the wavelength conversion material will mix with the light emitted by the wavelength conversion material. Thus, when a wavelength conversion material is used, the light emitted from the LED 42 is shifted in color from the actual light emitted from the LED chip 44.

For example, the LED arrays 26 may include a group of BSY or BSG LEDs 42 as well as a group of red LEDs 42. BSY LEDs 42 include an LED chip 44 that emits bluish light, and the wavelength conversion material is a yellow phosphor that absorbs the blue light and emits yellowish light. Even if some of the bluish light passes through the phosphor, the resultant mix of light emitted from the overall BSY LED 42 is yellowish light. The yellowish light emitted from a BSY LED 42 has a color point that falls above the Black Body Locus (BBL) on the 1931 CIE chromaticity diagram wherein the BBL corresponds to the various color temperatures of white light.

Similarly, BSG LEDs 42 include an LED chip 44 that emits bluish light; however, the wavelength conversion material is a greenish phosphor that absorbs the blue light and emits greenish light. Even if some of the bluish light passes through the phosphor, the resultant mix of light emitted from the overall BSG LED 42 is greenish light. The greenish light emitted from a BSG LED 42 has a color point that falls above the BBL on the 1931 CIE chromaticity diagram wherein the BBL corresponds to the various color temperatures of white light.

The red LEDs 42 generally emit reddish light at a color point on the opposite side of the BBL as the yellowish or greenish light of the BSY or BSG LEDs 42. As such, the reddish light from the red LEDs 42 mixes with the yellowish or greenish light emitted from the BSY or BSG LEDs 42 to generate white light that has a desired color temperature and falls within a desired proximity of the BBL. In effect, the reddish light from the red LEDs 42 pulls the yellowish or greenish light from the BSY or BSG LEDs 42 to a desired color point on or near the BBL. Notably, the red LEDs 42 may have LED chips 44 that natively emit reddish light wherein no wavelength conversion material is employed. Alternatively, the LED chips 44 may be associated with a wavelength conversion material, wherein the resultant light emitted from the wavelength conversion material and any light that is emitted from the LED chips 44 without being absorbed by the wavelength conversion material mixes to form the desired reddish light.

The blue LED chip 44 used to form either the BSY or BSG LEDs 42 may be formed from a gallium nitride (GaN), indium gallium nitride (InGaN), silicon carbide (SiC), zinc selenide (ZnSe), or like material system. The red LED chip 44 may be formed from an aluminum indium gallium nitride (AlInGaP), gallium phosphide (GaP), aluminum gallium arsenide (AlGaAs), or like material system. Exemplary yellow phosphors include cerium-doped yttrium aluminum garnet (YAG:Ce), yellow BOSE (Ba, O, Sr, Si, Eu) phosphors, and the like. Exemplary green phosphors include green BOSE phosphors, Lutetium aluminum garnet (LuAg), cerium doped LuAg (LuAg:Ce), Maui M535 from Lightscape Materials, Inc. of 201 Washington Road, Princeton, N.J. 08540, and the like. The above LED architectures, phosphors, and material systems are merely exemplary and are not intended to provide an exhaustive listing of architectures, phosphors, and materials systems that are applicable to the concepts disclosed herein.

As noted, each of the LED arrays 26 may include a mixture of red LEDs 42 and either BSY or BSG LEDs 42. The driver module 36 for driving the LED arrays 26 is illustrated in FIG. 13 according to one embodiment of the disclosure. The LED arrays 26 may be electrically divided into two or more strings of series connected LEDs 42. As depicted, there are three LED strings S1, S2, and S3. For clarity, the reference number “42” will include a subscript indicative of the color of the LED 42 in the following text where ‘R’ corresponds to red, ‘BSY’ corresponds to blue shifted yellow, ‘BSG’ corresponds to blue shifted green, and ‘BSX’ corresponds to either BSG or BSY LEDs. LED string S1 includes a number of red LEDs 42_{R}, LED string S2 includes a number of either BSY or BSG LEDs 42_{BSX}, and LED string S3 includes a number of either BSY or BSG LEDs 42_{BSX}. The driver module 36 controls the current delivered to the respective LED strings S1, S2, and S3. The current used to drive the LEDs 42 is generally pulse width modulated (PWM), wherein the duty cycle of the pulsed current controls the intensity of the light emitted from the LEDs 42.

The BSY or BSG LEDs 42_{BSX} in the second LED string S2 may be selected to have a slightly more bluish hue (less yellowish or greenish hue) than the BSY or BSG LEDs 42_{BSX} in the third LED string S3. As such, the current flowing through the second and third strings S2 and S3 may be tuned to control the yellowish or greenish light that is effectively emitted by the BSY or BSG LEDs 42_{BSX} of the second and third LED strings S2, S3. By controlling the relative intensities of the yellowish or greenish light emitted from the differently hued BSY or BSG LEDs 42_{BSX} of the second and third LED strings S2, S3, the hue of the combined yellowish or greenish light from the second and third LED strings S2, S3 may be controlled in a desired fashion.

The ratio of current provided through the red LEDs 42_{R} of the first LED string S1 relative to the currents provided through the BSY or BSG LEDs 42_{BSX} of the second and third LED strings S2 and S3 may be adjusted to effectively control the relative intensities of the reddish light emitted from the red LEDs 42_{R} and the combined yellowish or greenish light emitted from the various BSY or BSG LEDs 42_{BSX}. As such, the intensity and the color point of the yellowish or greenish light from BSY or BSG LEDs 42_{BSX} can be set relative to the intensity of the reddish light emitted from the red LEDs 42_{R}. The resultant yellowish or greenish light mixes with the reddish light to generate white light that has a desired color temperature and falls within a desired proximity of the BBL.

Notably, the number of LED strings Sx may vary from one to many and different combinations of LED colors may be used in the different strings. Each of the LED arrays 26 may have one or more strings Sx. Each LED string Sx may have LEDs 42 of the same color, variations of the same color, or substantially different colors, such as red, green, and blue. In one embodiment, a single LED string may be used for each LED array 26, wherein the LEDs in the string are all substantially identical in color, vary in substantially the same color, or include different colors. In another embodiment, three LED strings Sx with red, green, and blue LEDs may be used for each LED array 26, wherein each LED string Sx is dedicated to a single color. In yet another embodiment, at least two LED strings Sx may be used, wherein different colored BSY LEDs are used in one of the LED strings Sx and red LEDs are used in the other of the LED strings Sx.

The driver module 36 depicted in FIG. 13 generally includes rectifier and power factor correction (PFC) circuitry 67, conversion circuitry 68, and control circuitry 70. The rectifier and power factor correction circuitry 67 is adapted to receive an AC power signal (AC IN), rectify the AC power signal, and correct the power factor of the AC power signal. The resultant signal is provided to the conversion circuitry 68, which converts the rectified AC power signal to a DC power signal. The DC power signal may be boosted or bucked to one or more desired DC voltages by DC-DC converter circuitry, which is provided by the conversion circuitry 68. Internally, The DC power signal may be used to power the control circuitry 70 and any other circuitry provided in the driver module 36.

The DC power signal is also provided to the power bus, which is coupled to one or more power ports, which may be part of the standard communication interface. The DC power signal provided to the power bus may be used to provide power to one or more external devices that are coupled to the power bus and separate from the driver module 36. These external devices may include the communications module 38 and any number of auxiliary devices, which are discussed further below. Accordingly, these external devices may rely on the driver module 36 for power and can be efficiently and cost effectively designed accordingly. The rectifier and PFC circuitry 67 and the conversion circuitry 68 of the driver module 36 are robustly designed in anticipation of being required to supply power to not only its internal circuitry and the LED arrays 26, but also to supply power to these external devices as well. Such a design greatly simplifies the power supply design, if not eliminating the need for a power supply, and reduces the cost for these external devices.

As illustrated, the DC power signal may be provided to another port, which will be connected by the cabling to the LED arrays 26. In this embodiment, the supply line of the DC power signal is ultimately coupled to the first end of each of the LED strings S1, S2, and S3 in the LED arrays 26. The control circuitry 70 is coupled to the second end of each of the LED strings S1, S2, and S3 by the cabling. Based on any number of fixed or dynamic parameters, the control circuitry 70 may individually control the pulse width modulated current that flows through the respective LED strings S1, S2, and S3 such that the resultant white light emitted from the LED strings S1, S2, and S3 has a desired color temperature and falls within a desired proximity of the BBL. Certain of the many variables that may impact the current provided to each of the LED strings S1, S2, and S3 include: the magnitude of the AC power signal, the resultant white light, ambient temperature of the driver module 36 or LED arrays 26. Notably, the architecture used to drive the LED arrays 26 in this embodiment is merely exemplary, as those skilled in the art will recognize other architectures for controlling the drive voltages and currents presented to the LED strings S1, S2, and S3.

In certain instances, a dimming device controls the AC power signal. The rectifier and PFC circuitry 67 may be configured to detect the relative amount of dimming associated with the AC power signal and provide a corresponding dimming signal to the control circuitry 70. Based on the dimming signal, the control circuitry 70 will adjust the current provided to each of the LED strings S1, S2, and S3 to effectively reduce the intensity of the resultant white light emitted from the LED strings S1, S2, and S3 while maintaining the desired color temperature. Dimming instructions may alternatively be delivered from the communications module 38 to the control circuitry 70 in the form of a command via the communication bus.

The intensity or color of the light emitted from the LEDs 42 may be affected by ambient temperature. If associated with a thermistor S_{T} or other temperature-sensing device, the control circuitry 70 can control the current provided to each of the LED strings S1, S2, and S3 based on ambient temperature in an effort to compensate for adverse temperature effects. The intensity or color of the light emitted from the LEDs 42 may also change over time. If associated with an LED light sensor S_{L}, the control circuitry 70 can measure the color of the resultant white light being generated by the LED strings S1, S2, and S3 and adjust the current provided to each of the LED strings S1, S2, and S3 to ensure that the resultant white light maintains a desired color temperature or other desired metric. The control circuitry 70 may also monitor the output of the occupancy and ambient light sensors S_{O} and S_{A} for occupancy and ambient light information.

The control circuitry 70 may include a central processing unit (CPU) and sufficient memory 72 to enable the control circuitry 70 to bidirectionally communicate with the communications module 38 or other devices over the communication bus through an appropriate communication interface (I/F) 74 using a defined protocol, such as the standard protocol described above. The control circuitry 70 may receive instructions from the communications module 38 or other device and take appropriate action to implement the received instructions. The instructions may range from controlling how the LEDs 42 of the LED arrays 26 are driven to returning operational data, such as temperature, occupancy, light output, or ambient light information, that was collected by the control circuitry 70 to the communications module 38 or other device via the communication bus. The functionality of the communications module 38 may be integrated into the driver module 36, and vice versa.

With reference to FIG. 14, a block diagram of one embodiment of the communications module 38 is illustrated. The communications module 38 includes a CPU 76 and associated memory 78 that contains the requisite software instructions and data to facilitate operation as described herein. The CPU 76 may be associated with a communication interface 80, which is to be coupled to the driver module 36, directly or indirectly via the communication bus. The CPU 76 may also be associated with a wired communication port 82, a wireless communication port 84, or both, to facilitate wired or wireless communications with other lighting fixtures 10 and remote control entities.

The capabilities of the communications module 38 may vary greatly from one embodiment to another. For example, the communications module 38 may act as a simple bridge between the driver module 36 and the other lighting fixtures 10 or remote control entities. In such an embodiment, the CPU 76 will primarily pass data and instructions received from the other lighting fixtures 10 or remote control entities to the driver module 36, and vice versa. The CPU 76 may translate the instructions as necessary based on the protocols being used to facilitate communications between the driver module 36 and the communications module 38 as well as between the communications module 38 and the remote control entities. In other embodiments, the CPU 76 plays an important role in coordinating intelligence and sharing data among the lighting fixtures 10.

Power for the CPU 76, memory 78, the communication interface 80, and the wired and/or wireless communication ports 82 and 84 may be provided over the power bus via the power port. As noted above, the power bus may receive its power from the driver module 36, which generates the DC power signal. As such, the communications module 38 may not need to be connected to AC power or include rectifier and conversion circuitry. The power port and the communication port may be separate or may be integrated with the standard communication interface. The power port and communication port are shown separately for clarity. The communication bus may take many forms. In one embodiment, the communication bus is a 2-wire serial bus, wherein the connector or cabling configuration may be configured such that the communication bus and the power bus are provided using four wires: data, clock, power, and ground.

Those skilled in the art will recognize improvements and modifications to the embodiments of the present disclosure. All such improvements and modifications are considered within the scope of the concepts disclosed herein and the claims that follow.

What is claimed is:

1. A lighting fixture comprising:
a lens assembly having a central area bounded by a perimeter line;
a light source housing providing a mixing chamber with an opening covered by the lens assembly; and
at least one LED array mounted within the mixing chamber and adapted to emit light having a central axis, wherein the central axis passes through and along a portion of the perimeter line.

2. The lighting fixture of claim 1 wherein the perimeter line resides in a first plane and the at least one LED array is mounted such that the central axis forms an acute angle with the first plane.

3. The lighting fixture of claim 2 wherein the at least one LED array resides outside of the central area and is angled inward toward the perimeter line.

4. The lighting fixture of claim 3 wherein the acute angle is between about 10° and 80°.

5. The lighting fixture of claim 3 wherein the acute angle is between about 20° and 70°.

6. The lighting fixture of claim 3 wherein the acute angle is between about 30° and 60°.

7. The lighting fixture of claim 3 wherein the acute angle is about 30°.

8. The lighting fixture of claim 3 wherein the acute angle is about 45°.

9. The lighting fixture of claim 3 wherein the acute angle is about 60°.

10. The lighting fixture of claim 1 wherein the light source housing comprises at least one side wall, a back wall opposite the opening, and at least one angled wall that extends between the at least one side wall and the back wall.

11. The lighting fixture of claim 10 wherein the at least one LED array is mounted on an interior side of the at least one angled wall.

12. The lighting fixture of claim 11 wherein an interior portion of the at least one side wall, the back wall, and the at least one angled wall is reflective.

13. The lighting fixture of claim 11 wherein the at least one side wall comprises a plurality of side walls, the at least one angled wall comprises a plurality of angled walls, and the at least one LED array comprises a plurality of LED arrays, such that at least one of the plurality of LED arrays is located on each of the plurality of angled walls.

14. The lighting fixture of claim 11 wherein the at least one side wall consists of four side walls, the at least one angled wall consists of four angled walls, and the at least one LED array comprises a plurality of LED arrays, such that at least one of the plurality of LED arrays is located on each of the four angled walls.

15. The lighting fixture of claim 1 wherein an average light intensity along the perimeter line is less than or equal to three times an average light intensity in the central area.

16. The lighting fixture of claim 1 wherein an average light intensity along the perimeter line is less than or equal to 2.5 times an average light intensity in the central area.

17. The lighting fixture of claim 1 wherein an average light intensity along the perimeter line is less than or equal to two times an average light intensity in the central area.

18. The lighting fixture of claim 1 wherein an average light intensity along the perimeter line is about equal to an average light intensity in the central area.

19. The lighting fixture of claim 1 wherein the light source housing acts as a heatsink and the at least one LED array is thermally coupled to the light source housing, such that heat generated by LEDs of the at least one LED array is conducted to the light source housing and dissipated during operation.

20. The lighting fixture of claim 1 wherein an additional perimeter line extends about the perimeter line and at least one additional LED array is mounted within the mixing chamber and adapted to emit light having an additional central axis, wherein the additional central axis passes through and along a portion of the additional perimeter line.

21. The lighting fixture of claim 20 wherein:
the perimeter line resides in a first plane;
the at least one LED array is mounted such that the central axis forms an acute angle with the first plane;
the additional perimeter line resides in a second plane that is different than the first plane; and
the at least one additional LED array is mounted such that the additional central axis forms an acute angle with the second plane.

22. The lighting fixture of claim 21 wherein the at least one additional LED array resides outside of the central area and is angled inward toward the additional perimeter line.

23. The lighting fixture of claim 20 wherein an average light intensity along a border area between the perimeter line and the additional perimeter line is less than or equal to three times an average light intensity in the central area.

24. The lighting fixture of claim 20 wherein an average light intensity along a border area between the perimeter line and the additional perimeter line is less than or equal to 2.5 times an average light intensity in the central area.

25. The lighting fixture of claim 20 wherein an average light intensity along a border area between the perimeter line and the additional perimeter line is less than or equal to two times an average light intensity in the central area.

26. The lighting fixture of claim 20 wherein an average light intensity along a border area between the perimeter line and the additional perimeter line is about equal to an average light intensity in the central area.

27. The lighting fixture of claim 1 wherein the lens assembly comprises a diffuser.

28. The lighting fixture of claim 1 wherein the perimeter line resides in a first plane and the at least one LED array comprises a first LED array and a second LED array that are mounted opposite one another within a second plane such that:
the central axis forms an acute angle with the first plane; and
the first LED array and the second LED array reside outside of the central area and are angled inward toward the perimeter line.

29. The lighting fixture of claim 1 wherein the central axis passes through and along about one half or more of the perimeter line.

30. The lighting fixture of claim 1 wherein the central axis passes through and substantially completely along an entirety of the perimeter line.

31. A lighting fixture comprising:
a lens assembly having a diffuser and a central area bounded by a perimeter line;
a light source housing comprising a back wall and at least one angled wall that forms at least part of a mixing chamber with an opening covered by the lens assembly; and
at least one LED array mounted within the mixing chamber on an interior portion of the at least one angled wall and adapted to emit light having a central axis, wherein the central axis passes through and along a portion of the perimeter line.

32. The lighting fixture of claim 31 further comprising at least one side wall extending between the opening and the at least one angled wall.

33. The lighting fixture of claim 32 wherein the at least one side wall comprises a plurality of side walls.

34. The lighting fixture of claim 33 wherein the at least one side wall consists of four side walls, the at least one angled wall consists of four angled walls, and the at least one LED array comprise a plurality of LED arrays, such that at least one of the plurality of LED arrays is located on each of the four angled walls.

35. The lighting fixture of claim 31 wherein an average light intensity along the perimeter line is less than or equal to two times an average light intensity in the central area.

36. The lighting fixture of claim 31 wherein the at least one angled wall comprises a plurality of angled walls, and the at least one LED array comprise a plurality of LED arrays, such that at least one of the plurality of LED arrays is located on each of the plurality of angled walls.

37. The lighting fixture of claim 31 wherein the light source housing acts as a heatsink and the at least one LED array is thermally coupled to the at least one angled wall such that heat generated by LEDs of the at least one LED array is conducted to the light source housing and dissipated during operation.

38. The lighting fixture of claim 31 wherein the perimeter line resides in a first plane and the at least one LED array is mounted such that the central axis forms an acute angle with the first plane.

39. The lighting fixture of claim 38 wherein the at least one LED array resides outside of the central area and is angled inward toward the perimeter line.

40. The lighting fixture of claim 31 wherein the perimeter line resides in a first plane and the at least one LED array comprises a first LED array and a second LED array that are mounted opposite one another within a second plane such that:
the central axis forms an acute angle with the first plane; and
the first LED array and the second LED array reside outside of the central area and are angled inward toward the perimeter line.

41. The lighting fixture of claim 31 wherein the central axis passes through and along about one half or more of the perimeter line.

42. The lighting fixture of claim 31 wherein the central axis passes through and substantially completely along an entirety of the perimeter line.
